(19) United States
(12) Patent Application Publication
(10) Pub. No.: US 2006/0176311 A1
(43) Pub. Date: Aug. 10, 2006

(54) Image display device and image display method

(76) Inventors: Takayuki Kimoto, Hirakata-shi (JP); Yoshio Seki, Osaka-shi (JP); Akihiro Kuwabara, Nara-shi (JP)

Correspondence Address: SNELL & WILMER L.L.P., 600 ANTON BOULEVARD, SUITE 1400, COSTA MESA, CA, 92626, US

(21) Appl. No.: 10/561,885

(22) PCT Filed: Aug. 4, 2004
(86) PCT No.: PCT/JP04/05067

§ 371 Date: Dec. 20, 2005

(30) Foreign Application Priority Data
Jul. 9, 2003 (JP) 2003-194204

(51) Int. Cl. G09G 5/02

(52) U.S. Cl. 345/589

(57) ABSTRACT

A projector capable of performing color adjustment through a display mode which reduces the occurrence of color contrast phenomena. A main microcontroller (70), which determines a boundary position for dividing the display into a first area and a second area, and a switch control unit (56) switch the output of an output selector (55) according to pixel positions, so that image signals of a part of an image to be displayed in the first area are converted by a color conversion LUT (52) before being output, while image signals of a remaining part of the image to be displayed in the second area are directly output.

### TECHNICAL FIELD

The present invention relates to a display mode for color-adjusting an image displayed on a display medium such as a screen or display by a projector, DVD player, computer, etc.

### BACKGROUND ART

Devices which display an image on a display medium such as a screen or display commonly include a color adjustment function for adjusting colors according to a user's instruction.

A color adjustment function is particularly necessary with projectors that project an image based on image signals input with various color schemes onto a wide variety of screen types, since display colors are readily altered depending on the combination of the color scheme and the screen.

A conventional color adjustment function is described in Japanese Patent Application Publication No. 2002-262218.

An image correction device in this document disposes a reference window and a task window side-by-side on a single display screen, and displays the same image in both windows, scaled down to fit in the windows. The user can use a mouse to adjust colors of the image in the task window while referring to the original image in the reference window.

However, color contrast phenomena readily occur, making color adjustment difficult with the display mode of the above document.

The contrast phenomena referred to here occur as a result of an optical illusion whereby one color is affected by another color and appears differently from its actual color.

There are several types of contrast phenomena, but in particular, successive contrast and area contrast readily occur in the display mode of the above document.

Successive contrast is a phenomenon whereby when looking atone color and then another, the complementary color of the initial color appears as an afterimage. For example, a black afterimage appears after looking at white, and green appears after looking at red.

In the case of the display mode in the above document, when looking for a period of time at the image in the reference window, then looking at the image in the task window, the afterimage of the reference window appears superimposed on the image in the task window as a result of successive contrast, and perceiving true colors thus becomes difficult. Also, given that the size, the contour lines, and the shapes in the image of the reference window and the image in the task window match exactly, the afterimage is intensified by looking at the two windows one after another, making color adjustment all the more difficult.

Area contrast is a phenomenon whereby the characteristic of a color appears stronger as the area of the color increases. For example, dark colors appear darker, and light colors appear lighter.

In the case of the display mode in the above document, since the device scales down the image for full-screen display to, fit the window size, characteristics of the image colors appear weakened, making it impossible to accurately perceive the colors.

In view of this, an object of the present invention is to provide an image display device which can perform color adjustment using a display mode which suppresses the occurrence of color contrast phenomena.

### DISCLOSURE OF THE INVENTION

An image display device which achieves the above object is for receiving image signals and displaying an image, and includes a determining unit operable to determine a boundary position for dividing a displayed screen into a first area and a second area; a first display unit operable to specify, based on the boundary position, image signals pertaining to part of the image to be displayed in the first area, to convert a color attribute of said image signals, and to display the part of the image in the first area based on the converted image signals; and a second display unit operable to specify, based on the boundary position, image signals pertaining to a remaining part of the image to be displayed in the second area, and to display the remaining part of the image in the first area based on said image signals before or after converting a color attribute thereof.

In this structure, the image display device is realized, for example, by a projector which projects an image onto a screen.

The determining unit corresponds to processing whereby a main microcontroller 70 determines the coordinates of a boundary position for dividing the display projected on a screen into a first and second area.

Also, the first display unit corresponds to a series of processing, as shown in FIG. 7, whereby a switch control unit 56 receives the coordinates of the boundary position from the main microcontroller 70, specifies the timing according to which image signals to be displayed in the first area are to be inputted to an output selector 55 based on those coordinates, and outputs a switch signal showing the specified timing to the output selector 55, which outputs image signals color-converted by a color conversion LUT 52 in accordance with the timing shown by the switch signal.

Furthermore, the second display unit corresponds to a series of processing, as shown in FIG. 7, whereby the switch control unit 56 receives the coordinates of the boundary position from the main microcontroller 70, specifies the timing according to which image signals to be displayed in the second area are to be inputted to the output selector 55 based on those coordinates, and outputs a switch signal showing the specified timing to the output selector 55, which outputs the non-color-converted image signals, in accordance with the timing shown by the switch signal.

Alternatively, the second display unit corresponds to a series of processing, as shown in FIG. 13, whereby the switch control unit 56 receives the coordinates of the boundary position from the main microcontroller 70, specifies the timing according to which image signals to be displayed in the second area are to be inputted to the output selector 55 based on those coordinates, and outputs a switch signal showing the specified timing to the output selector 55 which outputs an image signal color-converted by a color conversion LUT 51 in accordance with the timing shown by the switch signal.

According to this structure, the image display device splits a single displayed image into two areas, displays one area as is, and displays the other area as color-converted in accordance with a color specified by a user, or color-converts each of the two areas and displays the result.

With this kind of display mode, it is possible to suppress the occurrence of color contrast phenomena compared with a conventional display mode which displays the same picture side-by-side, and the user can accurately perceive colors and perform adjustment.

Also, the first display unit may include a table storage subunit operable to store therein a color conversion table which maps a same value or a different value for each of a plurality of possible pixel values of image signals. Each pixel value pertaining to the part of the image to be displayed in the first area may be converted to a corresponding value in accordance with the color conversion table.

In this structure, the table storage unit corresponds to the color conversion LUT 52 which maps each of the possible pixel values of image signals one-to-one to a respective address, and stores the pixel values in the addresses. The first display unit inputs the pixel values pertaining to the part of the image to be displayed in the first area into the color conversion LUT 52, and obtains the corresponding pixel values in the addresses as converted pixel values.

According to this structure, the image display device can easily realize a color conversion mechanism by using a look-up table as a color conversion table which stores pre-conversion colors and converted colors mapped to one another.

Also, the determining unit may store a pixel position pertaining to the boundary position, which is for dividing the display screen vertically or horizontally, the first display unit may specify pixel values pertaining to the part of the image to be displayed in the first area by counting a reception timing of received image signals with reference to the stored pixel position, and the second display unit may specify pixel values pertaining to the remaining part of the image to be displayed in the second area by counting a reception timing of received image signals with reference to the stored pixel position.

In this structure, the function whereby the determining unit stores a pixel position pertaining to a boundary position for dividing the display either vertically or horizontally corresponds to a latch (in the switch control unit 56) which holds a coordinate value of a boundary position inputted from the main microcontroller 70.

Also, the function whereby the first display unit specifies pixel values pertaining to the part of the image to be displayed in the first area by counting a reception timing of received image signals with reference to a stored pixel position corresponds both to the function of a counter (in the switch control unit 56) which counts inputted pixels while resetting a counter value when a horizontal synchronization signal or a vertical synchronization signal is inputted, and outputs a switch signal when the counter value is reset and when the counted value equals the value held in the latch, and to the function of the selector 55 which switches between outputting inputted pixel values and color-converted pixel values according to the switch signals.

According to this structure, it is possible to realize a structure which splits a display into two areas and specifies signals for each area through a simple structure which uses a latch storing the coordinate value of a boundary position and a counter which counts the input clocks of image signals.

Also, the determining unit may determine the boundary position based on a user input, and may store the pixel position pertaining to the determined boundary position.

This structure corresponds to a function whereby the main microcontroller 70 receives operations of the user's mouse 130 or remote control 140 as user input, and determines the boundary position based on the coordinate position, etc. shown by the user input.

According to this structure, the user can use an input device such as a mouse or remote control to specify the boundary position.

Also, the determining unit may receive user input of information showing a position on the display screen and determine the boundary position so that the position shown by the information is included in the first area.

This structure corresponds to processing whereby the main microcontroller 70 receives input of a coordinate position on the display screen from the mouse 130 or remote control 140, determines a coordinate in the proximity to be the boundary position, and controls the color conversion circuit 40 having set the area including the inputted coordinate position to be the first area, and the other area to be the second area.

According to this structure, the user can use the mouse to specify the place they want to color-convert, since the position specified by the user is included in the first area which will be color-converted.

Also, the determining unit may receive user input of information showing a position on the display screen and determine the position shown by the information to be the boundary position.

This structure corresponds to processing whereby the main microcontroller 70 receives input of a coordinate position on the display from the mouse 130 or the remote control 140, and determines that coordinate to be the boundary position.

According to this structure, the user can use a mouse operation, etc. to indicate a position on the display and set that position to be the boundary position.

Also, the determining unit may receive user input of information showing a position on a display and determine a position separated a predetermined number of pixels from a pixel position pertaining to the position shown by the information to be the boundary position.

This structure corresponds to processing whereby the main microcontroller 70 receives input of a coordinate position on the display from the mouse 130 or remote control 140, and determines a position, for example, 50 pixels to the left of the x-coordinate of that coordinate position to be the boundary position.

According to this structure, it is possible to set a predetermined distance for the separation between the position specified by a mouse operation, etc. and the boundary position.

Also, the image display device may further include a modification unit operable to modify content of the color conversion table based on user input showing an instruction modifying content of the color conversion table.

Also, the modification unit may specify, based on user input, a pixel value to be converted and the pixel value after conversion, and update content of the color conversion table with the two specified values of the pixel signal.

This structure corresponds to processing whereby the main microcontroller 70 acquires the value of the color in the original color palette 3 and the value of the color in the target color palette 5 which was inputted by the user through the color adjustment screen of FIG. 9 or FIG. 10, and writes the value of the color in the target color palette in the portion of the addresses in the color conversion LUT 52 that correspond to the value of the color in the original color palette 3.

According to this structure, it is possible for a user to instruct a modification of the content of the color conversion table.

The modification unit may further receive a user input of information showing a position on a display and specify a pixel value of the position shown by the information as the pixel value to be converted.

This structure corresponds to a series of processing whereby the import position control unit 58 acquires, from signals inputted into the color conversion circuit 40, the value of the color signal at the coordinate position specified by the main microcontroller 70 which received input from the user, and returns the acquired value to the main microcontroller 70, which determines the returned value of the color signal to be the color to be modified.

According to this structure, the user can use a mouse operation, etc. to specify the color to be modified by selecting a pixel on the displayed image.

### BRIEF DESCRIPTION OF THE DRAWINGS

FIG. 1 shows a mode of use of a projector, being an embodiment of the present invention;

FIGS. 2A-2D show-examples of a display mode during color adjustment;

FIGS. 3A-3B show variations of a boundary line;

FIG. 4 show different variations of the boundary line;

FIG. 5 shows an external view of a projector 100;

FIG. 6 is a block diagram showing a construction of the projector 100;

FIG. 7 is a block diagram showing a construction of a color conversion circuit 40;

FIG. 8 is a block diagram showing a construction of a switch control unit 56;

FIG. 9 shows an example of an image for color adjustment and the boundary line displayed on-screen by an on-screen processing circuit 50;

FIG. 10 shows a variation of an original color specification means 4 and a target color specification means 6;

FIG. 11 is a flowchart showing operations of the projector 100;

FIG. 12 is a flowchart showing a variation of the switch control unit 56; and

FIG. 13 is a block diagram showing a variation of the color conversion circuit 40.

### BEST MODE FOR CARRYING OUT THE INVENTION

Embodiments of the present invention are described below.

### Embodiment 1

Brief Summary

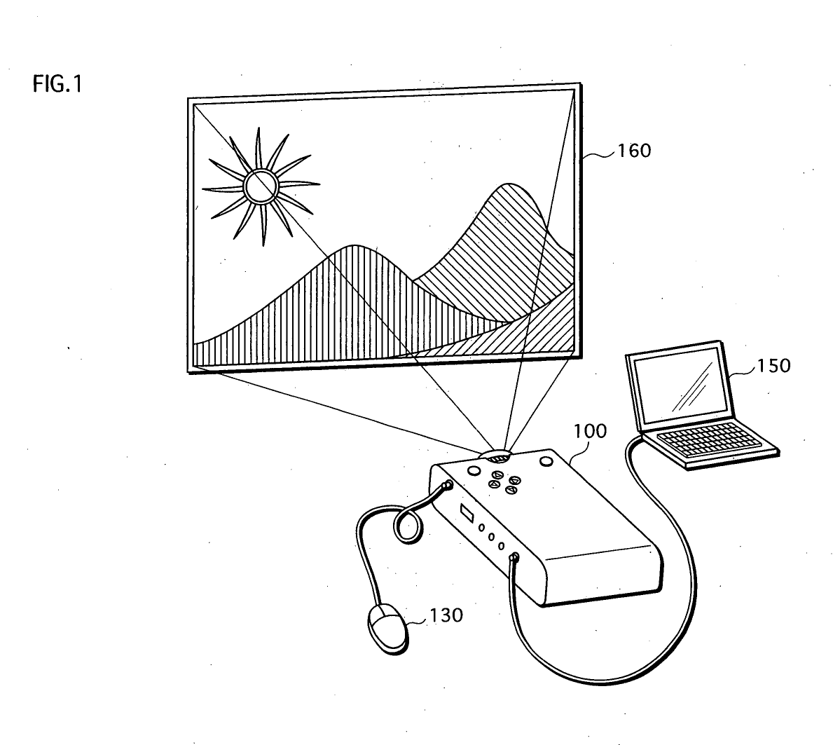

FIG. 1 shows a mode of use of a projector, being an embodiment of the present invention.

A projector 100 in this figure internally processes image signals from a PC 150 connected to an input terminal, develops the processed signals on a liquid crystal panel, and enlarges the developed image for display on a screen 160. If instructed during display to perform color adjustment by an operation of a user's mouse 130, the projector 100 divides the image displayed on the screen 160 vertically into two areas, displays one area using the original colors, and displays the other area after performing color conversion according to colors instructed by the user.

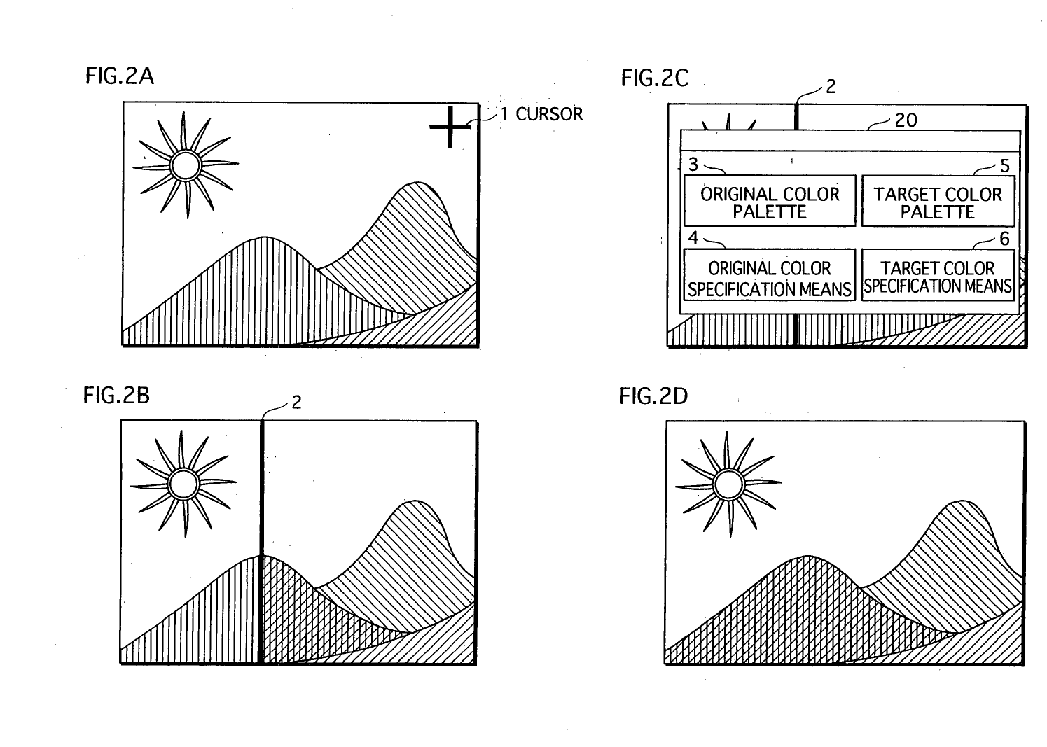

FIGS. 2A to 2B show an example of a display mode during color adjustment.

If the user moves the mouse 130 while an image is being displayed, a cursor is displayed on the image as shown in FIG. 2A. When the mouse is used to move the cursor and left-clicked at a suitable position, a boundary line 2, which divides the image vertically into two areas, is displayed as shown in FIG. 2B, and a color adjustment screen is then displayed. This color adjustment screen is for the user to input instructions for color adjustment, and is constituted so that the color to be adjusted and the color after adjustment can be inputted by a mouse operation. As shown in FIG. 2C, when color adjustment is instructed based on this screen, the area to the right of the boundary line is displayed with the portion having the color specified for adjustment changed to the specified color, and the area to the left of the boundary line is displayed with the original color. Left-clicking the right area with the mouse 130 inputs an instruction which approves the color modification, and as shown in FIG. 2D, the entire screen is thus color-converted based on the instructed color and displayed accordingly.

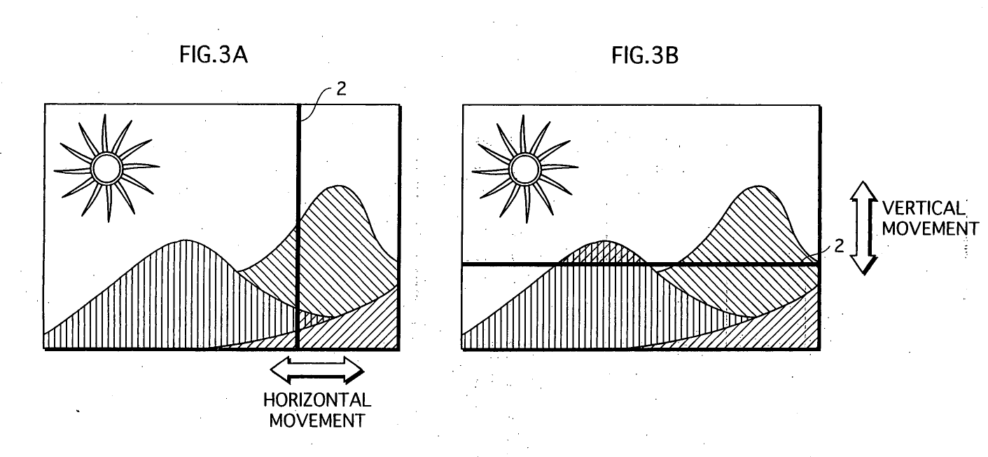

It is possible to move the position of the boundary line displayed on the screen in FIG. 2C using a mouse drag operation as in FIG. 3A, whereby the area displaying the original color and the area displaying the converted color change according to the movement of the boundary position. Also, if the cursor is aligned over the boundary line and left-clicked, the vertical boundary line becomes a horizontal boundary line as in FIG. 3B, and the display area with the original color and the display area with the converted color are displayed above and below each other. It is possible to change the boundary position using a mouse drag operation in this case as well.

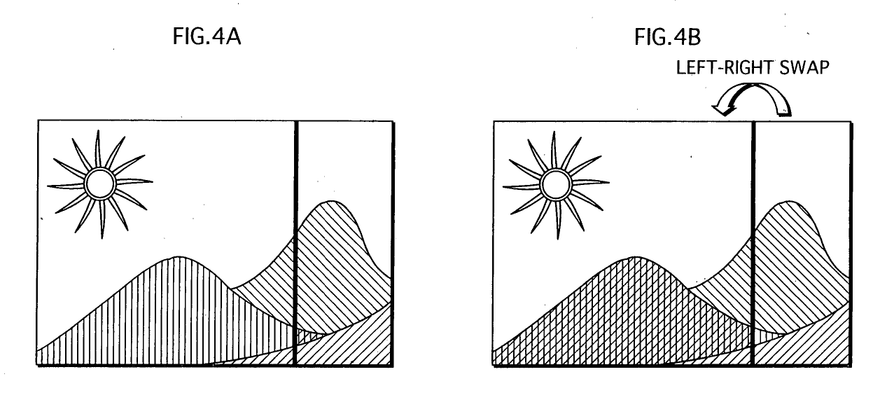

Additionally, the area showing the original color and the area showing the converted color can be switched as shown in FIG. 4A and FIG. 4B

Structure

A structure realizing such a display mode is described below.

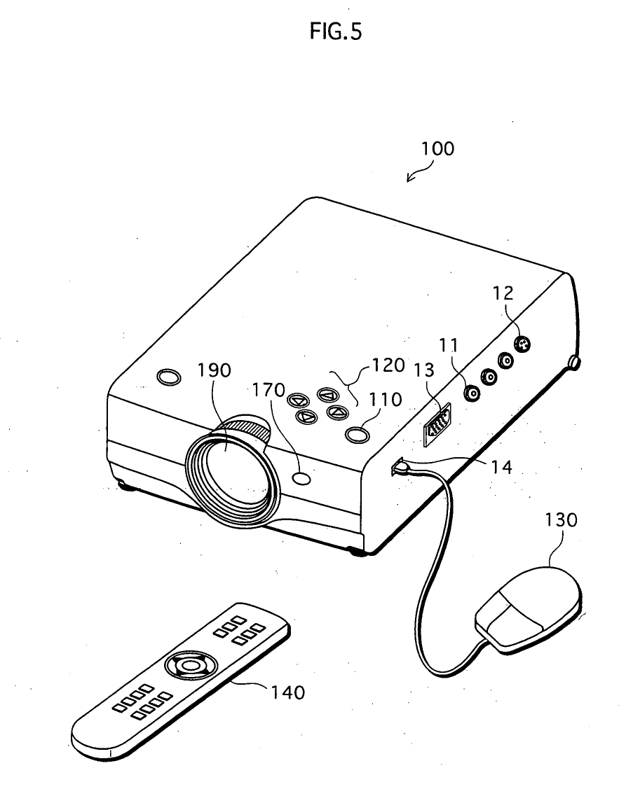

FIG. 5 shows an external view of the projector 100.

The projector 100 includes a USB connection terminal 14 to which the mouse 130 is connected, a video input terminal 11, an S-video input terminal 12, and a RGB/YPbPr input terminal 13 as input terminals on one side face of the casing. The projector 100 includes a remote control optical receiver 170 and a lens 190 for the input of a signal from a remote control 140 on the front surface of the casing, and includes direction keys 120 and a select button 110 on the top surface of the casing.

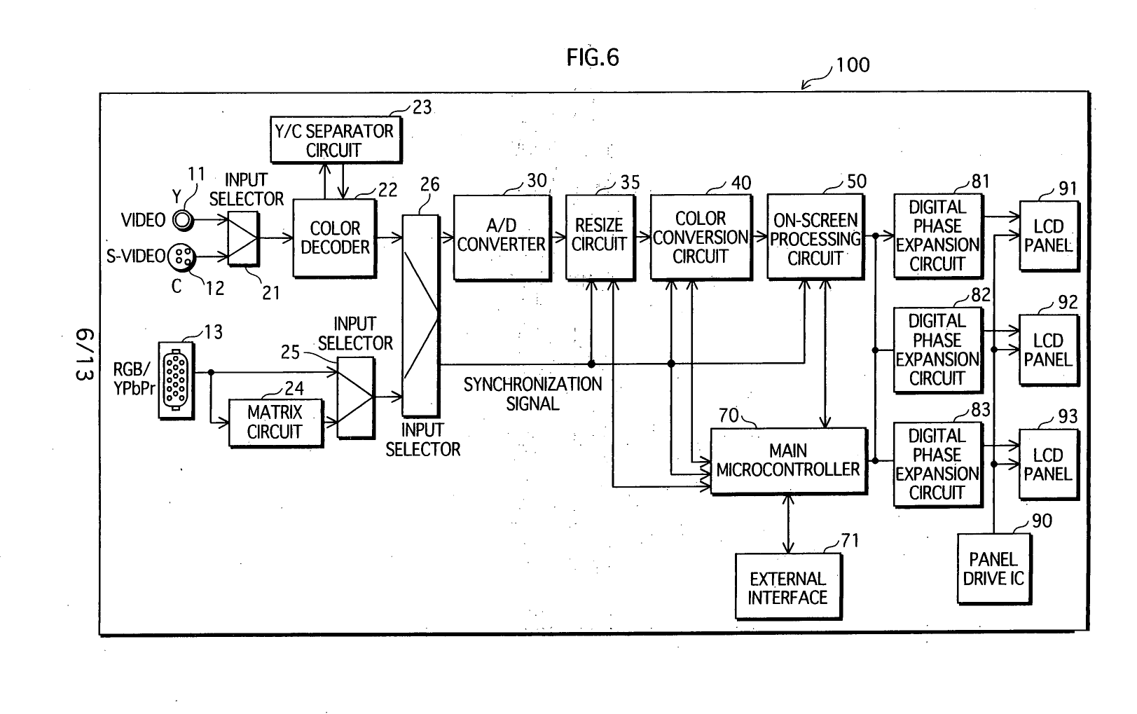

FIG. 6 is a block diagram showing the construction of the projector 100.

The projector 100 includes a color conversion circuit 40, an on-screen processing circuit 50, a main microcontroller 70, and an external interface 71 as a main body of the invention. The portion upstream of the color conversion circuit 40 is for preprocessing the various inputted image signals, and the portion downstream of the on-screen processing circuit 50 is for developing the image signal on the liquid crystal panel for display.

First, the upstream and downstream portions are briefly described below, and the main body of the invention is described later.

The upstream portion is constituted from a video input terminal 11, an S-video input terminal 12, a RGB/YPbPr input terminal 13, a color decoder 22, a Y/C separator circuit 23, a matrix circuit 24, an A/D converter 30, a resizing circuit 35, and input selectors 21, 25, and 26.

The video terminal 11, S-video input terminal 12, and RGB/YPbPr input terminal 13 are terminals for the input of an NTSC component video signal, an S-video signal, and a RGB signal or YPbPr signal, respectively. Signals inputted from these terminals are processed by the color decoder 22, Y/C separator circuit 23, or matrix circuit 24 depending on the standard of the video signal, then converted to a RGB signal and inputted to the A/D converter 30.

The color decoder 22 is a decoder for color-decoding a Y/C-separated signal or an inputted Y/C signal to a YPbPr signal.

The Y/C separator circuit 23 is for separating a composite video signal inputted by the color decoder 22 into a Y signal and a C signal.

The matrix circuit 24 performs predetermined conventional processing on a YPbPr signal inputted from the YPbPr terminal and plays back a RGB signal.

The A/D converter 30 is for converting an analog signal selected by the input selector 26 to a 10 bit digital signal.

The resizing circuit 35 is for resizing the digital signal according to the number of pixels in the LCD panels 91 to 93. The resizing circuit 35 temporarily stores resized image signals in internal memory, and outputs the image signals to the color conversion circuit 40 in scanning order, in synchronization with a synchronizing signal from the input selector 26. Also, update of the internal memory is stopped if there is a freeze instruction from the main microcontroller 70 (i.e., the resizing circuit 35 holds the image signal of one frame stored in the internal memory at the time of the instruction and repeatedly outputs the held image signal to the color conversion circuit 40 at the frame frequency while preventing that frame from being overwritten by the image signal of the next frame).

The downstream portion is constituted from digital phase expansion circuits 81, 82, and 83; a panel drive IC 90; and LCD panels 91, 92, and 93.

The digital phase expansion circuits 81, 82, and 83 are for phase-expanding a digital signal color-corrected by the color conversion circuit 40, with consideration for the operation speed of drivers (not shown) for LCD panels 91 to 93.

The panel drive IC (Integrated Circuit) 90 is for driving the LCD panels 91 to 93.

The LCD panels 91 to 93 are for color display of a digital signal color-corrected by the color conversion circuit 40 and phase-expanded by the digital phase expansion circuits 81 to 83.

Next, the main body of the construction is explained.

The color conversion circuit 40 identifies which of the two areas one frame worth of image signals outputted by the resizing circuit 35 belong to, based on the boundary position indicated by the main microcontroller 70, and directly outputs those image signals belonging to one area, while outputting those image signals belonging to the other area after color-conversion according to a color specified by the main microcontroller 70.

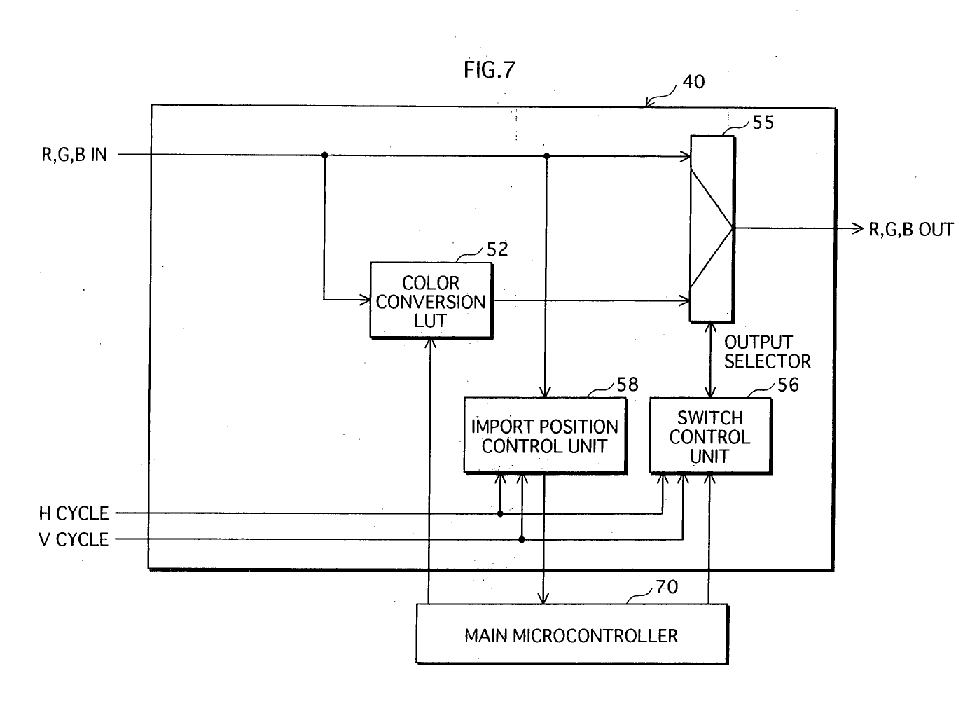

FIG. 7 is block diagram showing a construction of the color conversion circuit 40.

The color conversion circuit 40 in FIG. 7 is constituted from a color conversion LUT (Look Up Table) 52, an output selector 55, an import position control unit 58, and a switch control unit 56.

The color conversion LUT 52 maps the values of all possible input color signals to individual addresses of the internal memory, and each address holds the value of a color signal to be outputted. When color signals are inputted, the color conversion LUT 52 outputs corresponding color signals held in the addresses.

Color signals of the same value as the input color signals are held as initial values in the addresses. The content of the addresses can be rewritten later by a write operation of the main microcontroller 70 following color adjustment.

When coordinates of a boundary position for a two-way split display are indicated by the main microcontroller 70, the switch control unit 56 stores those coordinates and outputs switch signals appropriately to the output selector 55 to cause a switch.

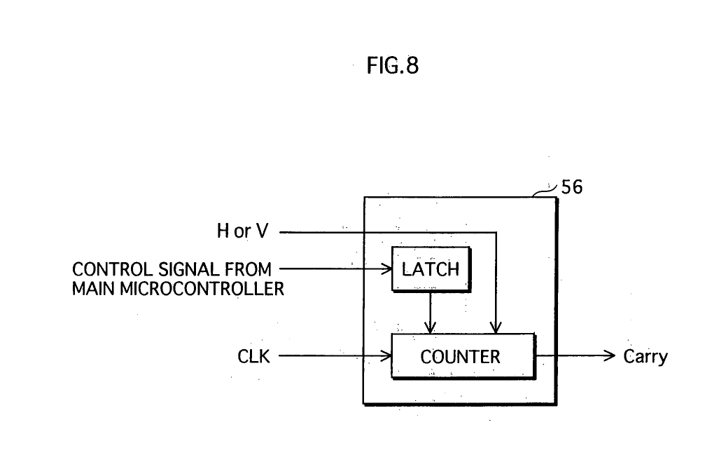

FIG. 8 is a block diagram showing a construction of the switch control unit 56.

The switch control unit 56 in this figure is formed mainly from a latch and a counter.

The latch holds coordinates of the boundary position inputted from the main microcontroller 70.

The counter detects the boundary of the two areas by counting the timing of single pixels or single lines of image signals input to the color conversion circuit 40, and carries out (i.e., outputs) a switch signal to the output selector 55 when the boundary is detected.

More specifically, the switch control unit 56 operates differently when dividing the image vertically as in FIG. 3A and when dividing the image horizontally as in FIG. 3B.

When dividing the image vertically, the switch control unit 56 first receives an instruction for vertical division and input of an x-coordinate of the boundary position from the main microcontroller 70, and holds the x-coordinate in the latch. The counter counts the input clocks while resetting the counter value each time a horizontal synchronization signal is inputted. These clocks are generated by the main microcontroller 70 based on the horizontal synchronization signal, or are generated by the resizing circuit 35. A single clock corresponds to the timing of a single pixel of an inputted image signal. The counter outputs a switch signal when reset by a horizontal synchronization signal and when the counted value equals the x-coordinate held in the latch.

When dividing the image horizontally, the switch control unit 56 receives an instruction for horizontal division and input of a y-coordinate of the boundary position from the main microcontroller 70, and holds the y-coordinate in the latch. The counter counts the input horizontal synchronization signals while resetting the counter value each time a vertical synchronization signal is inputted. The counter outputs a switch signal when reset by a vertical synchronization signal and when the counted value equals the y-coordinate held in the latch.

The output selector 55 outputs one of either the color signals input from the resizing circuit 35 or the color signals from the color conversion LUT 52 to the on-screen processing circuit 50 in accordance with the switch signals from the switch control unit 56.

More specifically, when dividing the image vertically, the output selector 55 directly outputs color signals inputted from the resizing circuit 35 when a switch signal is inputted by a reset from the switch control unit 56, and outputs color signals from the color conversion LUT 52 when a switch signal resulting from the latch and counter values becoming equal is inputted.

When dividing the image horizontally, the output selector 55 directly outputs color signals inputted from the resizing circuit 35 when a switch signal is inputted by a reset from the switch control unit 56, and outputs color signals from the color conversion LUT 52 when a switch signal resulting from the latch and counter values becoming equal is inputted.

Furthermore, if the main microcontroller 70 instructs the swapping of the left and right sides as shown in FIGS. 4A and 4B due to a mouse operation, etc., the output selector 55 reverses the switching of the output. This is similar if swapping the top and bottom.

The import position control unit 58 acquires the value of the color signal in the coordinate position specified by the main microcontroller 70 from the signals inputted to the color conversion circuit 40, and returns this value to the main microcontroller 70. This coordinate position specified by the main microcontroller 70 corresponds to the image portion to be color-adjusted specified by the user using a mouse operation.

Specifically, the import position control unit 58 is constituted from a horizontal synchronization signal counter: and a pixel clock counter, which are used to identify a coordinate position specified by the main microcontroller 70. This unit 58 acquires color signals in the identified position and outputs the acquired color signals to the main microcontroller 70.

According to this construction, when the image is left-clicked for example, the main microcontroller 70, which receives the input from the external interface, notifies the import position control unit 58 of the coordinates included in a 20 pixel by 20 pixel area centered on the cursor position. The import position control unit 58 specifies the position of the 20 pixel by 20 pixel area using the count of the horizontal synchronization signal counter and the count of the pixel clock counter, acquires the color signals contained therein, and outputs the acquired color signals to the main microcontroller 70.

The on-screen processing circuit 50 generates an image for on-screen display based on an instruction from the main microcontroller 70, composites this image with the image of the image signal outputted by the color conversion circuit 40, and outputs the composited image. In the present invention, an image for on-screen display refers particularly to an image for color adjustment and a boundary line.

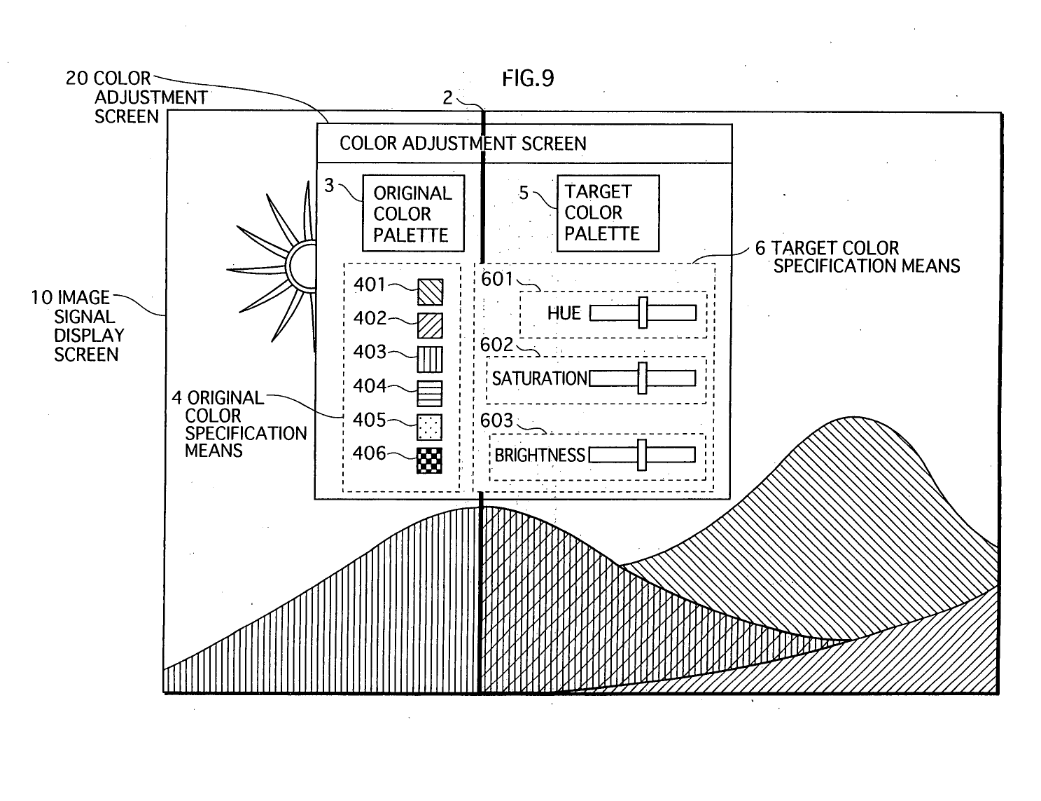

FIG. 9 shows an example of a color adjustment image and a boundary line displayed by the on-screen processing circuit 50.

An original color palette 3 in FIG. 9 shows the color to be color-adjusted.

An original color specification means 4 shows candidates for the color to be color-adjusted. Color palettes 401 to 406 show the 6 highest occurring colors in the 20 pixel by 20 pixel area acquired by the import position control unit 58.

A target color palette 5 shows how the color shown in the original color palette will appear after conversion.

A target color specification means 6 is for adjusting the color displayed in the target color palette 5. Colors are broken down into hue, saturation, and brightness, which are displayed on specification scales 601, 602, and 603.

Here, the boundary line 2 is displayed as thickness, lightness, and saturation. First, if the screen size is SXGA (1280 pixels by 1024 pixels), it is desirable to have a thickness 1% of the screen size or less. For example, when dividing the screen vertically, the thickness would be 1% of 1280 pixels, i.e., 12 pixels or less. Also, it is desirable for the saturation to be an achromatic color and for the lightness to be variable, although if it is invariable, it is desirable to display the boundary line at 20-40% of the 100% luminance. This is to reduce the effect of the boundary line as much as possible, since the boundary line may also be perceived as one of the images, and adversely affect the perception of the colors in the whole image.

The external interface 71 conveys inputs from various user operation units to the main microcontroller 70, these being inputs from the mouse 130 connected to the USB connection terminal 14, signals from the remote control 140 inputted to the remote control optical receiver 170, and the depressing of the direction keys 120 and the select button 110.

The main microcontroller 70 performs all controls for the entire device, including power control, fan control, temperature control, input switch control, etc. In particular, the main microcontroller 70 controls processing related to color adjustment by giving various instructions to the resizing circuit 35, the color conversion circuit 40, the on-screen processing circuit 50, etc. in response to a user's mouse operations, etc. input via the external interface 71 during color adjustment.

The following enumerates the processing of the main microcontroller 70 related to color adjustment.

(1) The main microcontroller 70 instructs the on-screen processing circuit 50 to display a cursor when the external interface 71 inputs a signal to the main microcontroller 70 in response to the mouse 130 being moved, a direction key on the remote control 140 being depressed, or a direction key 120 being depressed during display of an image.

Having the cursor displayed involves the main microcontroller 70 conveying to the on-screen processing circuit 50 the position coordinates of where the cursor is to be displayed and an instruction to composite the image of the cursor and an image of the image signal, and the on-screen processing circuit combining the image of the cursor with the image signal at the position coordinates in response to the instruction.

(2) Following this cursor display, the main microcontroller 70 instructs the resizing circuit 35 to freeze the image if the mouse 130 is left clicked, if the select button of the remote control 140 is depressed, or if the select button 110 is depressed during display of the cursor. In response, the resizing circuit 35 suspends resizing of the image signals of the next frame and repeatedly outputs the one frame worth of image signals held in internal memory to the color conversion circuit 40.

(3) Next, the main microcontroller 70 instructs the on-screen processing circuit 50 to display a boundary line. More specifically, the main microcontroller 70 acquires the position coordinates of the cursor when the mouse was left clicked or the select button was depressed, and determines a boundary position for dividing the image display screen being displayed on the screen 160 into two areas based on these coordinates. The main microcontroller 70 conveys to the on-screen processing circuit 50 the position coordinates of the determined boundary position and an instruction to composite an image representing the boundary line with the image of the image signals. The on-screen processing circuit then displays a vertical boundary line passing through the instructed boundary position coordinates. In the present embodiment, the main microcontroller 70 determines the boundary position to be at position coordinates in the proximity of the position coordinates of the cursor. A “proximity” of the cursor may be, for example, position coordinates 50 pixels to the left of the cursor.

This is to include the coordinate position of the cursor and the surrounding image in the area right of the boundary line as the object of color-adjustment. Also, by distancing the coordinates of the boundary line 50 pixels away from the position coordinates of the cursor and thus keeping the portion to be color-adjusted and the boundary line from being too far apart, it is easy for the user to visually compare the portion to be color-adjusted with the portion displayed to the left of the boundary line using the original color.

(4) Furthermore, the main microcontroller 70 instructs the on-screen processing circuit 50 to display the color adjustment screen.

More specifically, the main microcontroller 70 conveys to the on-screen processing circuit 50 information-regarding the structural content of the color adjustment screen and an instruction to composite the image of the color adjustment screen with the image of the image signals.

Here, the information regarding the construction content consists of the colors for display in the original color palette 3, the original color specification means 4 and the target color palette 5, as well as the positions of the indicators on the scales displayed in the target color specification means 6.

The main microcontroller 70 determines the initial values of the information regarding the structural content in the following way, and conveys them to the on-screen processing circuit 50.

When the mouse is left-clicked or the select button is depressed, the main microcontroller 70 acquires the color values in the 20 pixel by 20 pixel area centered on the cursor position (i.e. the color values of 400 pixels) from the import position control unit 58. The highest occurring color of the 400 pixels is then-set to be the initial color of the original color palette 3 and the target color palette 5. Also, the six highest occurring colors, including the initial color, are set to be the colors in the color palettes 401 to 406 of the original color specification means. Furthermore, the main microcontroller 70 calculates the values of the hue, saturation, and brightness of the color in the original color palette 3, and determines the position of the indicators on the specification scales 601, 602, and 603 of the target color specification means 6 according to those values.

(5) The main microcontroller 70 instructs the on-screen processing circuit 50 to update the structural content of the color adjustment screen according to mouse operations, etc. performed on the color adjustment screen.

More specifically, each time one of the color palettes 401 to 406 is selected by a mouse operation, etc., the main microcontroller 70 instructs the on-screen processing circuit 50 to change the color of the original color palette 3 to the color of the selected color palette, and sets the indicators on the specification scales 601 to 603 of the target color specification means 6 to show the updated color of the original color palette 3.

When the position of an indicator on the specification scales 601 to 603 is moved by a mouse operation, etc., the main microcontroller 70 calculates the value of the color based on the position of the indicator after movement and displays the calculated color in the target color palette 5.

(6) When the cursor is placed and left-clicked on an image portion outside the color adjustment screen while it is being displayed, the main microcontroller 70 instructs the color conversion circuit 40 to convert the area right of the boundary line to the color specified on the color adjustment screen. More specifically, the main microcontroller 70 acquires the value of the color in the original color palette 3 and the value of the color in the target color palette 5, and rewrites the portion of the address in the color conversion LUT 52 corresponding to the value of the color in the original color palette 3 with the value of the color in the target color palette 5. The main microcontroller 70 then conveys to the switch control unit 56 the coordinates of the boundary line and an instruction to perform switching.

In response, the color conversion circuit 40 directly outputs the image signals left of the boundary line, switches the selector 55 at the boundary line, and outputs the image signals right of the boundary line as converted by the color conversion LUT 52.

(7) When the image signals right of the boundary line are converted and being displayed, and an image portion outside the color adjust screen is left-clicked again, the main microcontroller 70 instructs the switch control unit 56 of the color conversion circuit 40 to output all of the video signals of a single frame through the color conversion circuit 40.

As a result, the entire image of a single frame is color-converted and displayed.

Operation

The following describes the operations of the projector 100 with the above construction.

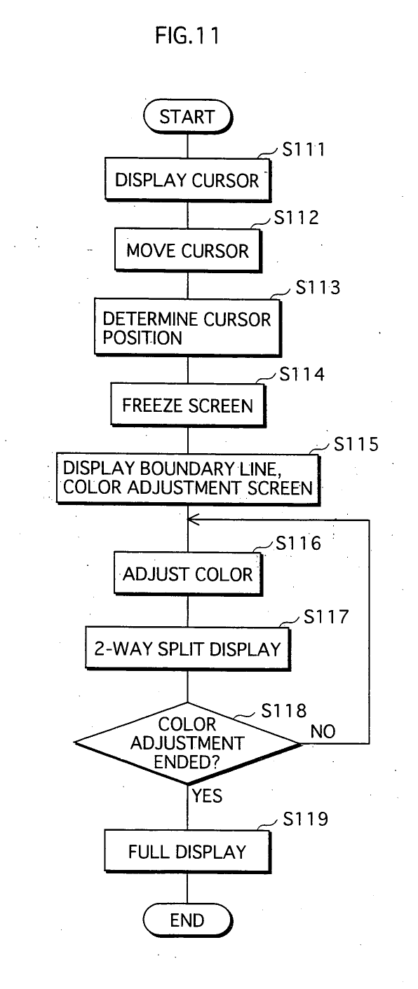

FIG. 11 is a flowchart showing the operations of the projector 100.

When the mouse 130 is moved while the image is being displayed as in FIG. 1, the main microcontroller 70 instructs the on-screen processing circuit 50 to display the cursor as in FIG. 2A (Step S111).

The main microcontroller 70 instructs the on-screen processing circuit 50 to move the display position of the cursor in response to movement of the mouse 130 (Step S112).

When the mouse 130 is left-clicked, the main microcontroller 70 acquires the coordinates of the display position of the cursor, determines the boundary position based on those coordinates, and conveys to the on-screen processing circuit 50 the boundary position and an instruction to generate a boundary line. More specifically, the main microcontroller 70 determines the boundary position to be the x-coordinate of a position 50 pixels to the left of the cursor display position, and conveys to the on-screen processing circuit 50 the x-coordinate and an instruction to generate a vertical boundary line (Step S113).

At this time, the main microcontroller 70 also conveys to the import position control unit 58 the coordinates of the 20 pixel by 20 pixel area centered on the acquired coordinate of the cursor display position, and acquires the color signals of the coordinates for each pixel from the import position control unit 58. The main microcontroller 70 then determines the structural content of the color adjustment screen based on the acquired color signals, conveys to the on-screen processing circuit 50 the information regarding the structural content, and causes the on-screen processing circuit 50 to generate the color adjustment screen.

At substantially the same time as Step S113, the main microcontroller 70 instructs the resizing circuit 35 to freeze the image (Step 114).

According to this instruction, the resizing circuit 35 freezes the image by repeatedly outputting the image of the single frame stored in internal memory. Also, the on-screen processing circuit 50 composites the vertical boundary line and the color adjustment screen with the image from the resizing circuit 35, and outputs the composited image. This results in a display as in FIG. 2C (Step S115).

In response to mouse operations on the color adjustment screen, the main microcontroller 70 causes the on-screen processing circuit 50 to update the structural content of the color adjustment screen (Step S116).

When the image portion outside the color adjustment screen is left-clicked, the main microcontroller 70 updates the content of the color conversion LUT 52 according to the content of the color adjustment screen and causes the switch control unit 56 to perform switch controlling. As a result, the color conversion circuit 40 directly outputs the image signals left of the boundary line, switches the output selector 55 at the boundary line, and outputs image signals converted by the color conversion LUT 52 to the right of the boundary line (Step S117).

When a mouse operation is performed on the color adjustment screen while the screen is 2-way split-displayed in this way, processing returns to Step S116 and is repeated. Alternatively, when the image outside the color adjustment screen is left-clicked, the main microcontroller 70 views this as the end of color adjustment. The main microcontroller 70 then causes the on-screen processing circuit 50 to end the combining of the boundary line and the color adjustment screen, instructs the switch control unit 56 to output all of the image signals of a single frame through the color conversion LUT 52, whereby the rewritten portion of the color conversion LUT 52 is color-converted and displayed as shown in FIG. 2D (Step S119).

As a result of the above, the projector 100 of the present embodiment divides a single displayed image into two areas, displays one area as is, and displays the other area as converted in accordance with a color specified by a user. This kind of display mode can suppress the occurrence of color contrast phenomena compared with a conventional display mode which displays the same picture side-by-side, and enables accurate perception and adjustment of colors.

### Other Embodiments

The present invention is not limited to the above embodiment, and may be implemented as follows.

(1) The image display device of the present invention is not limited to a projector, and may be any device which displays an image on various display media, such as a plasma display, LCD, CRT, etc.

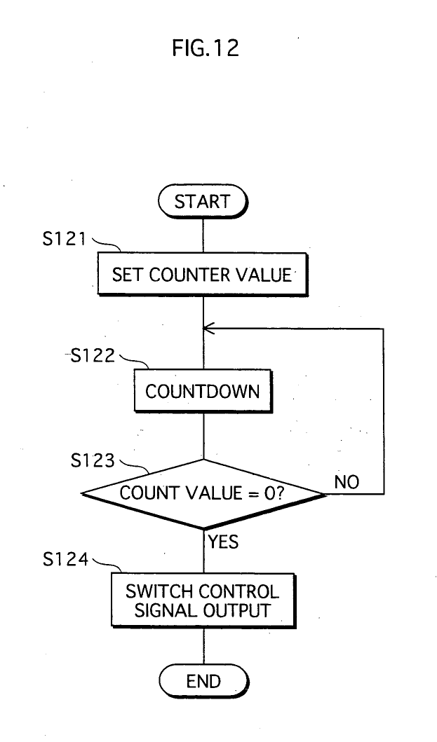

(2) The switch control unit 56 maybe constituted to countdown as in FIG. 12. When horizontal synchronization signals are inputted, with the coordinates of the boundary line stored in the latch by the main microcontroller 70, the counter sets the value held in the latch and counts down from the set value (Step S122). When the counter value reaches 0, the counter outputs a switch signal (Step 124).

(3) The original color specification means 4 may display fixed colors (e.g., red, green, blue, yellow, cyan, magenta) instead of displaying colors acquired by the import position control unit 58. Also, these colors may be shown as letters (e.g., R, G, B, Y, C, M) instead of being shown as colors.

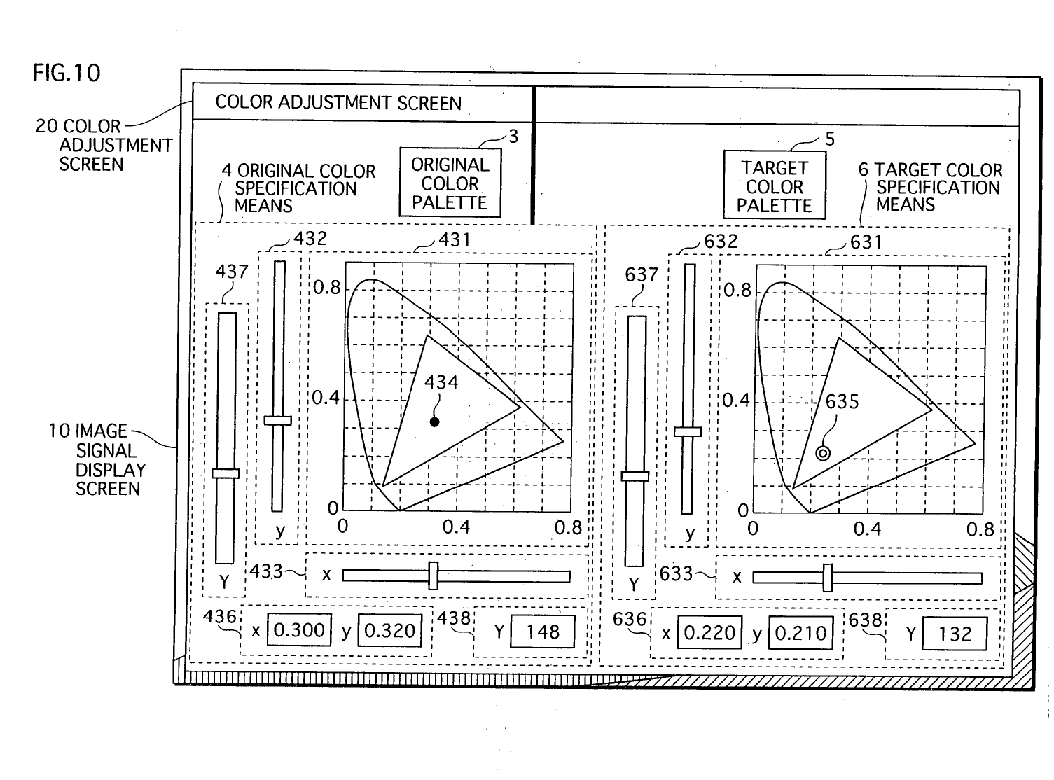

(4) The original color specification means 4 and target color specification means 6 of the color adjustment screen may be displayed with an x-y chromaticity diagram as shown in FIG. 10.

431 in FIG. 10 is an x-y-chromaticity diagram of the original color specification means 4. 434 is the color coordinate showing the color to be adjusted, and corresponds to the color displayed in the original color palette 3. On the left side and below the x-y chromaticity diagram are an x-coordinate specification scale 433, a y-coordinate specification scale 432, and a lightness specification scale 437. By moving an indicator on these scales using a mouse operation, etc., the coordinates of the color coordinate 434 changes in conjunction with the movement, making it possible to change the color to be adjusted. The color coordinate 434 may also be directly moved using a mouse operation.

436 and 438 in the lower portion show the value of the color coordinates and the value of lightness respectively, whereby the values change in conjunction with the indicators on the scales. Values may be directly input into this portion to specify a color coordinate.

The same applies to the target color specification means 6. 631 is an x-y chromaticity diagram of the target color specification means 6. 635 is the color coordinate showing the target color after adjustment, and corresponds to the color displayed in the target color palette 5. On the left side and below the x-y chromaticity diagram are an x-coordinate specification scale 633, a y-coordinate specification scale 632, and a lightness specification scale 637. By moving an indicator on these scales using a mouse operation, etc., the coordinates of the color coordinate 635 changes in conjunction with the movement, making it possible to change the target color. The color coordinate 635 may also be directly moved using a mouse operation.

636 and 638 in the lower portion show the value of the color coordinates and the value of lightness respectively, whereby the values change in conjunction with the indicators on the scales. Values can be directly input into this portion to specify a color coordinate.

(5) The original color specification means 4 may be constituted without any one of the elements in the above (4). For example, the original color specification means 4 may be constituted without 436 and 438, or may be constituted with only the various scales, minus the x-y chromaticity diagram.

The same applies to the target color specification means 6.

(6) The structural contents of the color adjustment screens in FIG. 9 and FIG. 10 may be composited and implemented as one screen.

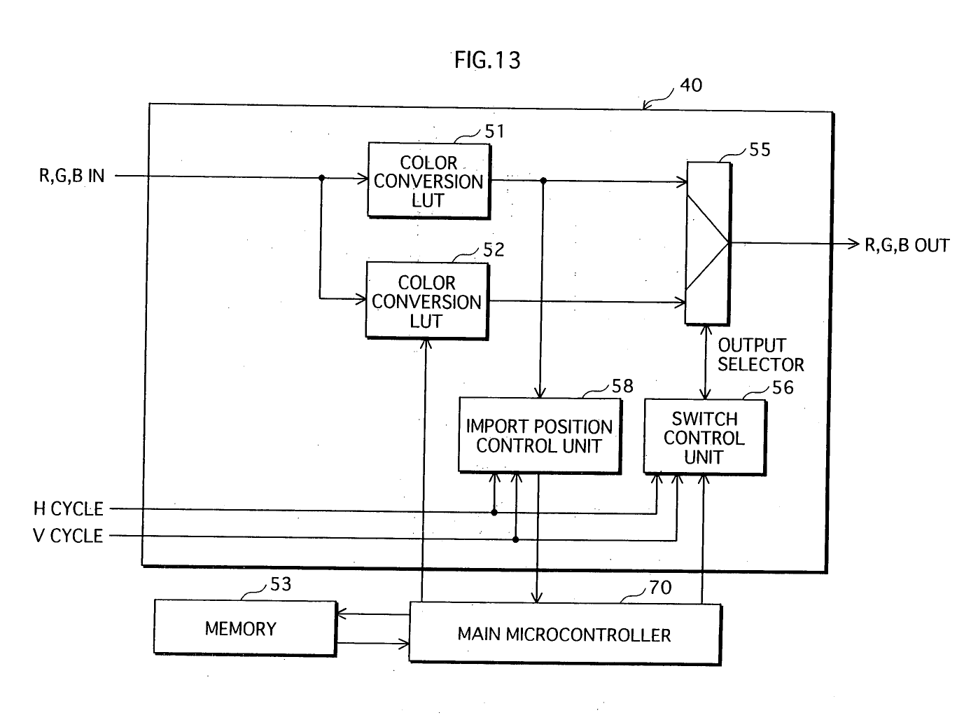

(7) The construction of the color conversion circuit 40 may be constituted as in FIG. 13.

In FIG. 13, a color conversion LUT 51 has been added to the block diagram of FIG. 7.

The color conversion LUT 51 holds in advance, in addresses of input color signals, color signals that can be accurately reproduced according to the voltage and transmissivity characteristics of the LCD panels 91 to 93. The color conversion LUT 52 first holds the same content as the color conversion LUT 51 as initial values, but later the content is updated by the main microcontroller 70.

Other aspects of the construction are the same as in FIG. 7.

As a result of this construction, color signals converted by the color conversion LUT 51 are outputted before color adjustment. Later when color adjustment is performed and the screen is split 2-way, color signals from the color conversion LUT 51 and color signals from the color conversion LUT 52 are alternately switched and outputted.

(8) In the construction of FIG. 13, the main microcontroller 70 may alternately update the color signals of the color conversion LUT 51 and color conversion LUT 52. Specifically, the main microcontroller 70 alternately updates the color conversion LUTs each time there is a color adjustment. For example, the main microcontroller 70 updates color signals in the color conversion LUT 52 for the first color adjustment, updates a color signal in the color conversion LUT 51 for the next color adjustment, and updates a color signal in the color conversion LUT 52 for the color adjustment after that.

As a result of this construction, it is possible to perform further color adjustments on an image which has been color-adjusted.

(9) Also as shown in FIG. 13, the main microcontroller 70 may store update histories for the color conversion LUTs 51 and 52 in a memory 53. In response to an instruction from a mouse operation, etc. to revert the content of the color conversion LUTs 51 and 52 to that of a previous history, the main microcontroller 70 reads the history from the memory 53 and writes it to the color conversion LUTs 51 and 52. As a result, it is possible to revert the colors of an image to a previous status.

(10) In FIG. 7, an operation unit may be included instead of the color conversion LUT 52.

The operation unit is composed of a circuit which performs a 3×3 matrix operation regarding the RGB value of the color signals and a circuit which amplifies the gain of a matrix-operated signal. Here, the matrix coefficient and gain coefficient are configured by the main microcontroller 70. The matrix coefficient is a value approximating the target color signal specified by the color adjustment screen.

(11) The color conversion LUT 52 may be 8×8×8 bits. Alternatively, the color conversion LUT 52 may be set to be 5×5×5 bits to reduce memory volume, and the remaining bits may be interpolated using an interpolation circuit.

(12) Processing of the structural elements shown in FIGS. 6, 7, and 8 may be realized as a computer-executable program.

(13) The on-screen processing circuit 50 handles display and combining of images with regard to cursor display and boundary line display, although display of a cursor corresponding to an import position and display and combining of a boundary line under the control of the main microcontroller 70 may be performed in the color conversion circuit 40.

(14) The switch control unit 56 and output selector 55 are disposed downstream of the color conversion LUT in the color conversion circuit 40, although an input selector may be used instead of the output selector 55 and disposed upstream of the color conversion LUT. That is, when color signals are inputted into the input selector from the resizing circuit 35, the input selector switches between directly outputting the color signals to the on-screen processing circuit 50 and inputting the color signals to the color conversion LUT 52, according to the switch signal from the switch control unit 56. The color conversion LUT 52 color-converts only the color signals inputted by the input selector and outputs the result to the on-screen processing circuit 50.

### INDUSTRIAL APPLICABILITY

The present invention can be used in a device such as a projector, television, DVD player, computer, etc., which displays images on a display unit.

1. An image display device for receiving image signals and displaying an image, comprising:
a determining unit operable to determine a boundary position for dividing a displayed screen into a first area and a second area;
a first display unit operable to specify, based on the boundary position, image signals pertaining to part of the image to be displayed in the first area, to convert a color attribute of said image signals, and to display the part of the image in the first area based on said converted image signals; and
a second display unit operable to specify, based on the boundary position, image signals pertaining to a remaining part of the image to be displayed in the second area, and to display the remaining part of the image in the first area based on said image signals before or after converting a color attribute thereof.

2. The image display device of claim 1, wherein
the first display unit includes a table storage subunit operable to store therein a color conversion table which maps a same value or a different value for each of a plurality of possible pixel values of image signals, and
each pixel value pertaining to the part of the image to be displayed in the first area is converted to a corresponding value in accordance with the color conversion table.

3. The image display device of claim 2, wherein
the determining unit stores a pixel position pertaining to the boundary position, which is for dividing the display screen vertically or horizontally,
the first display unit specifies pixel values pertaining to the part of the image to be displayed in the first area by counting a reception timing of received image signals with reference to the stored pixel position, and
the second display unit specifies pixel values pertaining to the remaining part of the image to be displayed in the second area by counting a reception timing of received image signals with reference to the stored pixel position.

4. The image, display device of claim 3, wherein the determining unit determines the boundary position based on a user input, and stores the pixel position pertaining to the determined boundary position.

5. The image display device of claim 4, wherein the determining unit receives a user input of information showing a position on the display screen and determines the boundary position so that the position shown by the information is included in the first area.

6. The image display device of claim 4, wherein the determining unit receives a user input of information showing a position on the display screen and determines the position shown by the information to be the boundary position.

7. The image display device of claim 4, wherein the determining unit receives a user input of information showing a position on a display and determines a position separated a given number of pixels from a pixel position pertaining to the position shown by the information to be the boundary position.

8. The image display device of claim 2, further comprising:
a modification unit operable to modify content of the color conversion table based on a user input showing an instruction modifying content of the color conversion table.

9. The image display device of claim 8, wherein the modification unit specifies, based on a user input, a pixel value to be converted and the pixel value after conversion, and updates content of the color conversion table with the two specified values of the pixel signal.

10. The image display device of claim 9, wherein the modification unit receives a user input of information showing a position on a display and specifies a pixel value of the position shown by the information as the pixel value to be converted.

11. An image display method for receiving image signals and displaying an image, comprising the steps of:
determining a boundary position for dividing a displayed screen into a first area and a second area;
specifying, based on the boundary position, image signals pertaining to part of the image to be displayed in the first area, converting a color attribute of said image signals, and displaying the part of the image in the first area based on said converted image signals; and
specifying, based on the boundary position, image signals pertaining to a remaining part of the image to be displayed in the second area, and displaying the remaining part of the image in the second area based on said image signals before or after converting a color attribute thereof.
